(19) United States
(12) Patent Application Publication
(10) Pub. No.: US 2013/0076766 A1
(43) Pub. Date: Mar. 28, 2013

(54) MAP DATA DISTRIBUTION APPARATUS, ELECTRONIC APPARATUS, AND MAP UPDATE SYSTEM

(71) Applicant: Nobutoshi Yamagishi, Obu-city (JP)

(72) Inventor: Nobutoshi Yamagishi, Obu-city (JP)

(73) Assignee: DENSO CORPORATION, Kariya-city (JP)

(21) Appl. No.: 13/610,200

(22) Filed: Sep. 11, 2012

(30) Foreign Application Priority Data
Sep. 28, 2011 (JP) 2011-213004

(51) Int. Cl. G06T 1/00

(52) U.S. Cl. 345/522; 345/501

(57) ABSTRACT

A difference map distribution server wirelessly distributes update information contained in map data to a navigation apparatus that stores map data representing a road network using multiple links and nodes. Specifically, a difference information database stores difference data items to be categorized into multiple types of update information that enable update information about the same link or node occurred during the same period to be categorized into different types. A difference data extraction portion extracts a difference data item categorized into a type of update information to be distributed to a targeted navigation apparatus from the difference data items categorized into the multiple types of update information stored in the difference information database. A distribution controller wirelessly distributes the difference data item categorized into the extracted type of update information to the navigation apparatus via a network interface.

### CROSS REFERENCE TO RELATED APPLICATION

This application is based on Japanese Patent Application No. 2011-213004 filed on Sep. 28, 2011, the disclosure of which is incorporated herein by reference.

### TECHNICAL FIELD

The present disclosure relates to a technology that distributes map data.

### BACKGROUND

[Patent document 1] JP 4684228 B2 (US 2007/282524 A1)

Conventionally, there is known an electronic apparatus that stores map data and performs processes using the map data. For example, a navigation apparatus performs a map display process, a route search process, and a guidance process. The map display process displays a map image representing the map data. The route search process searches roads represented by the map data for a route corresponding to a search condition. The guidance process guides a vehicle from the present location to a destination.

Generally, the map data represents a road on the map on a link basis. A node corresponds to a connection point between links. Links and nodes represent a road network. Thus, the map data includes a link and node as a road element for representing a road network. The map data contains a variety of information about links and nodes. Further, such a variety of information includes traffic regulation, link shape, road type, road width, number of lanes, road structure, speed limit, and guidance image.

The electronic apparatus stores the map data that is generated based on actual road situations. Since road situations vary daily, the map data generated in the past may differ from actual road situations.

To that end, an electronic apparatus in practical use periodically replaces the stored map data with the most recent data. However, the information updated according to a change in the road situation occupies a small portion in the entire map data. It is inefficient to replace the entire map data.

According to a proposed configuration, a server is provided to manage the most recent map data. The server wirelessly distributes difference data to a navigation apparatus. The difference data represents updated information contained in the map data. According to the map data distribution system described in Patent document 1, for example, a map distribution request contains an area that requests the map distribution. A navigation terminal transmits the map distribution request to the map distribution server. When receiving the map distribution request, the map distribution server extracts undistributed link data from the map data storage portion and distributes it to the navigation terminal. The undistributed link data provides the applicable update range containing a link at least part of which belongs to a requested area included in the map distribution request. The navigation terminal receives the link data from the map distribution server and reflects the received link data on the map data stored in itself.

The configuration described in Patent document 1 can greatly suppress the quantity of data to be distributed in comparison with the case of distributing the entire map data. However, there may occur an update that improves the map accuracy targeted for a wide area, for example. In such a case, the update content may increase the quantity of difference data and also increase communications traffic to wirelessly distribute the difference data.

### SUMMARY

The present disclosure has been made in consideration of the foregoing. It is therefore an object of the present disclosure to provide a technology that suppresses communications traffic to wirelessly distribute difference data to an electronic apparatus from a server.

To achieve the above object, according to a first example of the present disclosure, a map data distribution apparatus is provided as follows. The map data distribution apparatus functions as a server, stores map data representing a road network using a plurality of road elements, and wirelessly distributes update information contained in the map data to an electronic apparatus. The electronic apparatus performs a map utilization process using the map data. The map data distribution apparatus includes a difference storage device, an extraction device, and a distribution device. The difference storage device stores difference data items as update information about a specified road element. Each of the difference data items is stored to be categorized into one of a plurality of different types of update information. The extraction device extracts a difference data item categorized into an extracted type of update information to be distributed to the electronic apparatus, out of the difference data items categorized into the plurality of different types of update information stored in the difference storage device. The distribution device wirelessly distributes as distributed difference data the difference data item categorized into the extracted type, which is extracted by the extraction device, to the electronic apparatus.

This configuration can decrease the communications traffic for wireless distribution of difference data in comparison with a conventional configuration that wirelessly distributes, at a time, difference data items that represents the whole of update information occurred during the same period with respect to a specified road element. A map utilization process performed on the electronic apparatus does not use all the information contained in the map data at a time. The map utilization process generally uses part of the information contained in the map data as needed. The map data contains different types of information about road elements depending on utilization purposes. The different types of information may be needed at different timings, respectively. To that end, the map data distribution apparatus according to the present disclosure can change or select a timing for distributing each of difference data items, which represent update information about a specified road element, depending on different types of update information. In this manner, the map data distribution apparatus can decrease the amount of difference data to be distributed as well as the communications traffic for wireless distribution of difference data.

According to a second example of the present disclosure, an electronic apparatus is provided as follows. The electronic apparatus stores map data representing a road network using a plurality of road elements and performs a map utilization process using the map data, while cooperating with a server that wirelessly distributes update information contained in the map data. The electronic apparatus includes a process information transmission device, a difference data reception device, and a process device. The process information transmission device wirelessly transmits process execution information to the server when performing the map utilization process. The process execution information represents the map utilization process to be performed. The difference data reception device wirelessly receives a difference data item categorized into an extracted type of update information from the server. The difference data item categorized into the extracted type of update information is extracted by the server, out of difference data items categorized into a plurality of different types of update information with respect to a specified road element in response to the process execution information transmitted by the process information transmission device. The process device performs the map utilization process using map data on which the difference data item categorized into the extracted type of update information is reflected.

According to a third example of the present disclosure, a map update system is provided to include an electronic apparatus and a server. The electronic apparatus stores map data representing a road network using a plurality of road elements, and performs a map utilization process using the map data. The server that wirelessly distributes distributed difference data representing update information contained in the map data. The electronic apparatus includes a process information transmission device, a difference data reception device, and a process device. The process information transmission device wirelessly transmits, when performing the map utilization process, process execution information representing the map utilization process to the server. The difference data reception device wirelessly receives the distributed difference data from the server as a response to the process execution information transmitted by the process information transmission device. The process device performs the map utilization process using map data on which the distributed difference data received by the difference data reception device is reflected. The server includes a difference storage device, a process information reception device, an extraction device, and a distribution device. The difference storage device stores difference data items as update information about a specified road element. Each of the difference data items is stored to be categorized into one of a plurality of different types of update information. The process information reception device receives the process execution information from the electronic apparatus. The extraction device extracts, when the process information reception device receives the process execution information from the electronic apparatus, a difference data item categorized into an extracted type of update information out of the difference data items categorized into the plurality of different types of update information stored in the difference storage device. Herein, the difference data item categorized into the extracted type of update information is to be used in the map utilization process indicated by the process execution information transmitted from the electronic apparatus. The distribution device wirelessly distributes as the distributed difference data the difference data item categorized into the extracted type of update information, which is extracted by the extraction device, to the electronic apparatus.

The above second and third examples can provide an advantage comparable with that of the first example.

### BRIEF DESCRIPTION OF THE DRAWINGS

The above and other objects, features, and advantages of the present disclosure will become more apparent from the following detailed description made with reference to the accompanying drawings. In the drawings:

FIG. 1 is a block diagram showing a configuration of a map update system according to an embodiment;

FIG. 2 shows an example of updating map data;

FIG. 3 shows timings to distribute difference data;

FIG. 4 shows an example of updating a road network represented by links and nodes;

FIG. 5 shows dependency between difference data;

FIG. 6 shows a configuration of a difference data ID;

FIG. 7 is a flowchart showing a process while a map display process is performed; and

FIG. 8 is a flowchart showing a process performed when a route search process starts.

### DETAILED DESCRIPTION

An embodiment of the present disclosure will be described with reference to the accompanying drawings.

### 1. Overall Configuration

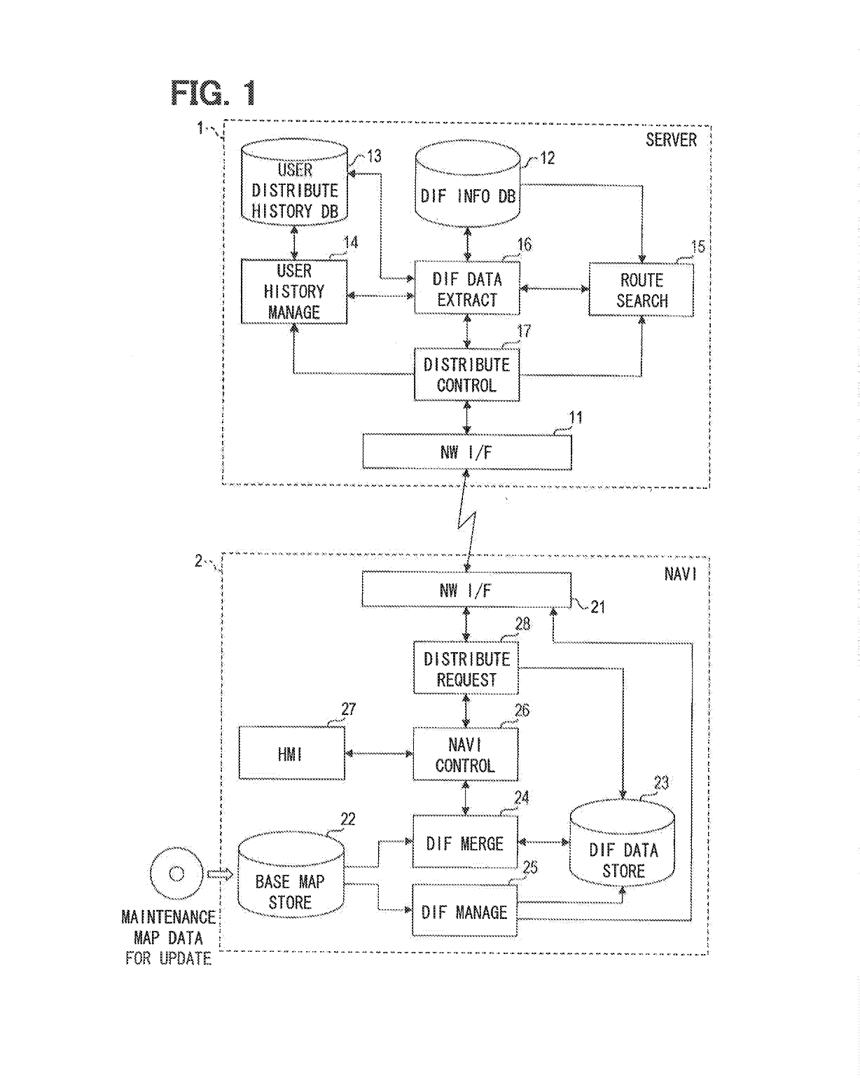

FIG. 1 is a block diagram showing a configuration of a map update system according to the embodiment. The map update system includes a difference map distribution server 1 and a navigation apparatus 2 (also referred to as an electronic apparatus). The difference map distribution server 1 is wirelessly communicable with multiple navigation apparatuses 2 (one apparatus shown in FIG. 1) used by multiple users via a wireless communication network (mobile telephone network). The navigation apparatuses 2 include different types. Some are fixedly mounted on a vehicle and others are portably usable outside the vehicle.

The navigation apparatus 2 stores map data and is capable of performing various processes using the map data. The difference map distribution server 1 manages the most recent map data. The map data contains difference data (i.e., difference data items) that represents updated information contained in the map data. The difference map distribution server 1 functions as a server that wirelessly distributes the difference data to navigation apparatuses 2.

### 2. Configuration of the Difference Map Distribution Server

The following describes a specific configuration of the difference map distribution server 1. As shown in FIG. 1, the difference map distribution server 1 includes a network interface (hereinafter referred to as a network I/F) 11, a difference information database (hereinafter referred to as a difference information DB) 12, a user distribution history database (hereinafter referred to as a user distribution history DB) 13, a user history management portion 14, a route search portion 15, a difference data extraction portion 16, and a distribution controller 17.

The network I/F 11 enables wireless communication with the navigation apparatus 2 via a wireless communication network (mobile telephone network). The difference information DB 12 stores difference data items from the past to the present. The most recent map data is managed in the difference map distribution server 1 and is periodically updated in accordance with changes in road situations. The difference data represents updated information that is contained in the map data and corresponds to added, modified, or deleted information. The difference information DB 12 stores the difference data items as well as information about the update dates.

The user distribution history DB 13 stores the (navigation apparatus-specific) distribution history of difference data items distributed to the navigation apparatus 2 on the basis of each navigation apparatus 2 (user). The user history management portion 14 updates the distribution history stored in the user distribution history DB 13 each time the difference data item is distributed. The user history management portion 14 also deletes unneeded distribution history. The unneeded distribution history occurs as follows. For example, the most recent map data may be distributed as maintenance map data in the form of a DVD or an SD card to users. In such a case, the earlier difference data item existing before the most recent map data can be reflected on the map data in the navigation apparatus 2 using the DVD or SD card.

A user may manipulate the navigation apparatus 2 to start the route search process. In such a case, the route search portion 15 of the difference map distribution server 1 receives information needed for the route search process from the navigation apparatus 2 and performs the route search process using the most recent map data (all difference data). The information needed for the route search process includes search conditions such as a present location and a destination.

The difference data extraction portion 16 of the difference map distribution server 1 extracts a difference data item to be distributed to the navigation apparatus 2 from difference data items stored in the difference information DB 12. For example, the difference data extraction portion 16 extracts a difference data item based on a result of the route search process performed by the route search portion 15. The difference data extraction portion 16 also excludes a difference data item already distributed to the navigation apparatus 2 based on the distribution history about the difference data items stored in the user distribution history DB 13.

The distribution controller 17 controls communication with the navigation apparatus 2 via the network I/F 11. Specifically, the distribution controller 17 distributes a difference data item extracted by the difference data extraction portion 16 to the navigation apparatus 2. The distribution controller 17 allows the user history management portion 14 to update the distribution history stored in the user distribution history DB 13. The distribution controller 17 also receives information needed for the route search process from the navigation apparatus 2 and allows the route search portion 15 to perform the route search process based on the received information.

The navigation apparatus 2 transmits the information including identification information (user ID) specific to each navigation apparatus 2 to the difference map distribution server 1. The difference map distribution server 1 identifies multiple users (multiple navigation apparatuses 2) based on the user ID included in the received information.

### 3. Configuration of the Navigation Apparatus

The following describes a specific configuration of the navigation apparatus 2. As shown in FIG. 1, the navigation apparatus 2 includes a network interface (hereinafter referred to as a network I/F) 21, a base map storage portion 22, a difference data storage portion 23, a difference merge portion 24, a difference management portion 25, a navigation processor 26, a human-machine interface portion (hereinafter referred to as an HMI portion) 27, and a distribution request portion 28.

The network I/F 21 enables wireless communication with the difference map distribution server 1 via a wireless communication network (mobile telephone network). The base map storage portion 22 stores map data. The map data represents a road on the map on a link basis. A node corresponds to a connection point between links. Links and nodes represent a road network. The map data contains a variety of information about links and nodes. The information includes traffic regulation, link shape, road type, road width, number of lanes, road structure, speed limit, and guidance image.

The difference data storage portion 23 stores difference data items received from the difference map distribution server 1. The difference merge portion 24 generates map data that reflects the difference data items. To do this, the difference merge portion 24 merges difference data items stored in the difference data storage portion 23 with the map data as a base stored in the base map storage portion 22. The difference merge portion 24 supplies the generated map data to the navigation processor 26.

Maintenance map data may update the map data stored in the base map storage portion 22. The update may cause unneeded difference data items. In such a case, the difference management portion 25 deletes the unneeded difference data items from the difference data storage portion 23. The difference management portion 25 also provides notification to the difference map distribution server 1 via the network I/F 21.

The navigation processor 26 performs a map display process, a route search process, and a guidance process using map data generated from the difference merge portion 24. The map display process displays a map image represented by the map data. The route search process searches roads represented by the map data for a route according to a search condition. The guidance process provides guidance from the present location to the destination along roads represented by the map data.

The HMI portion 27 includes an input portion, a display portion, a speaker, and a microphone. The input portion accepts the user's input manipulation. The display portion displays a map image. The speaker outputs audio information such as route guidance. The microphone inputs the user's voice.

The distribution request portion 28 controls communication with the difference map distribution server 1 via the network I/F 21. Specifically, the distribution request portion 28 requests the difference map distribution server 1 to distribute difference data. The distribution request portion 28 allows the difference data storage portion 23 to store difference data or difference data items received from the difference map distribution server 1.

### 4. Processes

The following describes map data update processes performed by the map update system according to the embodiment.

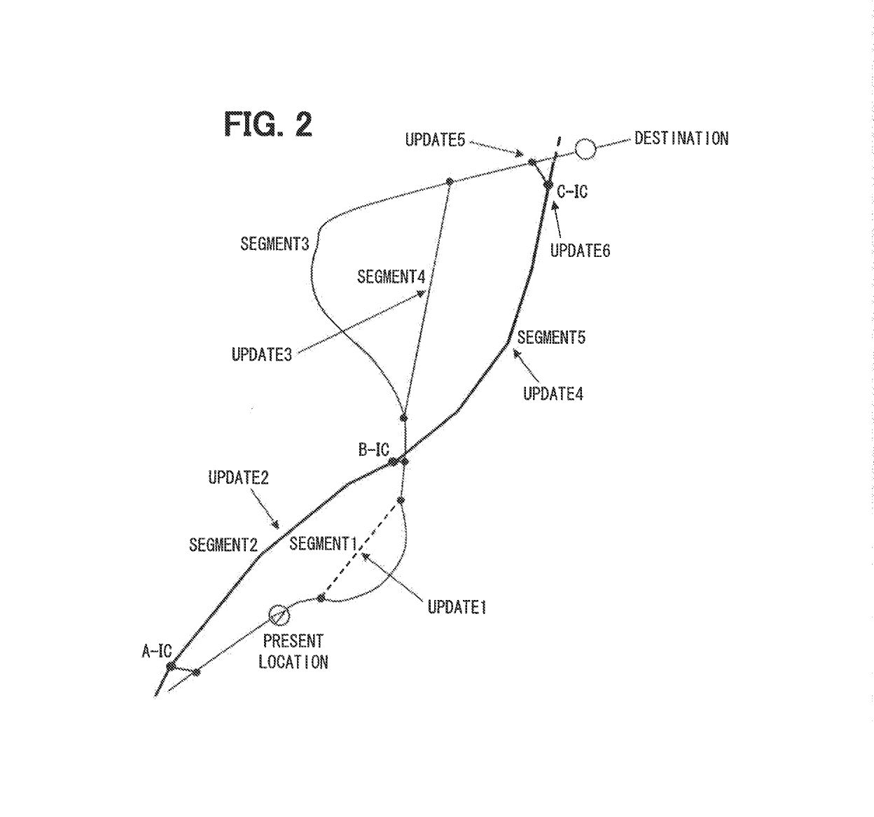

The difference map distribution server 1 partially updates information contained in the map data in accordance with an actual change in the road situation. The difference information DB 12 then stores a difference data item indicating the updated information as well as the update date. FIG. 2 shows an example of updating the map data at six locations (updates 1 through 6). The fine line represents an ordinary road. The thick line represents a highway.

Update 1 shows that a bypass belongs to segment 1 of the ordinary road and is now closed. The update date is October in 2010. Update 2 shows that segment 2 of the highway is widened and the road shape is changed due to the road improvement. The update date is October in 2010. Update 3 shows that a bypass (segment 4) is opened for segment 3 in the ordinary road. The update date is November in 2010. Update 4 shows that the highway is extended from B-IC (interchange) to C-IC to form segment 5. The update date is December in 2010. Update 5 shows that C-IC is opened. The update date is December in 2010. Update 6 shows that an image diagram (an image for the guidance process) for C-IC is added. The update date is December in 2010.

The difference map distribution server 1 distributes the updated information as difference data to the navigation apparatus 2. Each navigation apparatus 2 is provided with a neighboring area, that is, a surrounding area familiar to the user such as a range within a predetermined distance around the users home or prefectural and city governments to which the users home belongs. The difference map distribution server 1 distributes all undistributed difference data items concerning the neighboring area to the navigation apparatus 2 at a specified timing such as a predetermined clock time or the time when an accessory (ACC) switch is turned on or off.

On the other hand, the difference map distribution server 1 does not distribute all difference data items concerning a distant area (an area other than the neighboring area). The difference map distribution server 1 distributes a difference data item needed for the navigation apparatus 2 in real time depending on the usage situation of map data in the navigation apparatus 2. The map update system according to the embodiment can distribute difference data items at different timings according to the types of update information even if the difference data items represents update information about the same link or node that is updated during the same period.

The difference data items stored in the difference information DB 12 is categorized into network change (hereinafter referred to as NW change), shape change, attribute change, and guidance information change according to the contents or types of update information. The NW change covers difference data items that represent addition or deletion of links or nodes and changes in traffic regulations such as passage prohibition and right or left turn prohibition. The shape change covers difference data items that represent a change in the link shape itself. The attribute change covers difference data items that represent changes in road types (e.g., highway or national road), road width, number of lanes, road structures (e.g., bridge, tunnel, or elevated highway), and speed limit. The guidance information change covers difference data items that represent changes in image diagrams, audio guidance (e.g., destination, IC, or road name), and lane diagrams at intersections. In this manner, updated information about the same link or node can be categorized into different types of update information even if the update occurs during the same period.

As shown in FIG. 2, for example, the difference data item for update 1 shows that the bypass is closed. The difference data item for update 3 shows that the bypass is opened. The difference data item for update 4 shows that the highway is extended. The difference data item for update 5 shows that C-CI is opened. These difference data items are categorized into the NW change. The difference data item for update 2 shows that the road is widened. This difference data item is categorized into the attribute change. The difference data item for update 2 shows that the road improvement changes the road shape. This difference data item is categorized into the shape change. The difference data item for update 6 shows that an image diagram is added. This difference data item is categorized into the guidance information change.

The difference map distribution server 1 distributes difference data items categorized into the type of update information applicable to the navigation apparatus 2 in real time depending on whether the map data stored in the navigation apparatus 2 is used for the map display process (browsing), the route search process, or the guidance process after the route search.

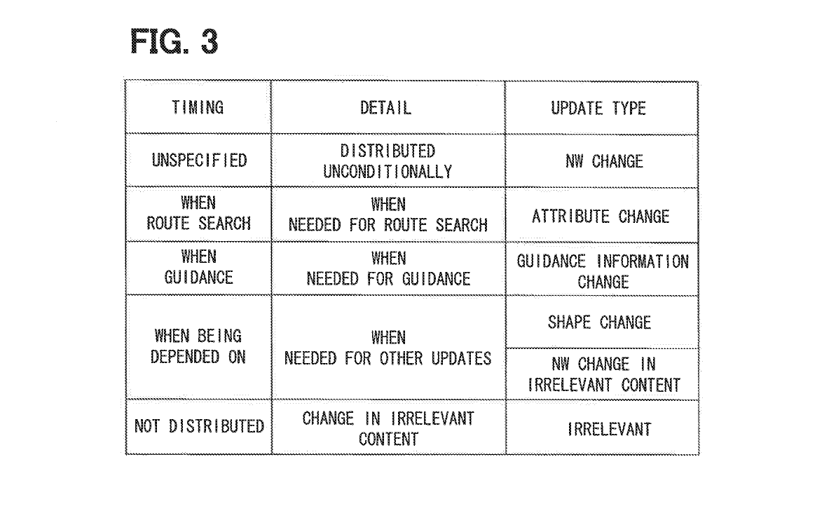

As shown in FIG. 3, the difference data item categorized into the NW change is distributed regardless of the map data usage situation. On the other hand, the difference data item categorized into the attribute change is distributed when the route search process requires the difference data. The difference data item categorized into the guidance information change is distributed when the guidance process requires the difference data. At the timing to perform the route search process, the difference map distribution server 1 preferentially distributes a difference data item categorized into the type of update information used for the route search process and prevents distribution of a difference data item categorized into the type of data not used for the route search process. At the timing to perform the guidance process, the difference map distribution server 1 preferentially distributes a difference data item categorized into the type of update information used for the guidance process and prevents distribution of a difference data item categorized into the type of data not used for the guidance process.

The difference data item categorized into the shape change is not distributed independently, but is distributed when needed to give consistency to the map data that reflects another difference data item.

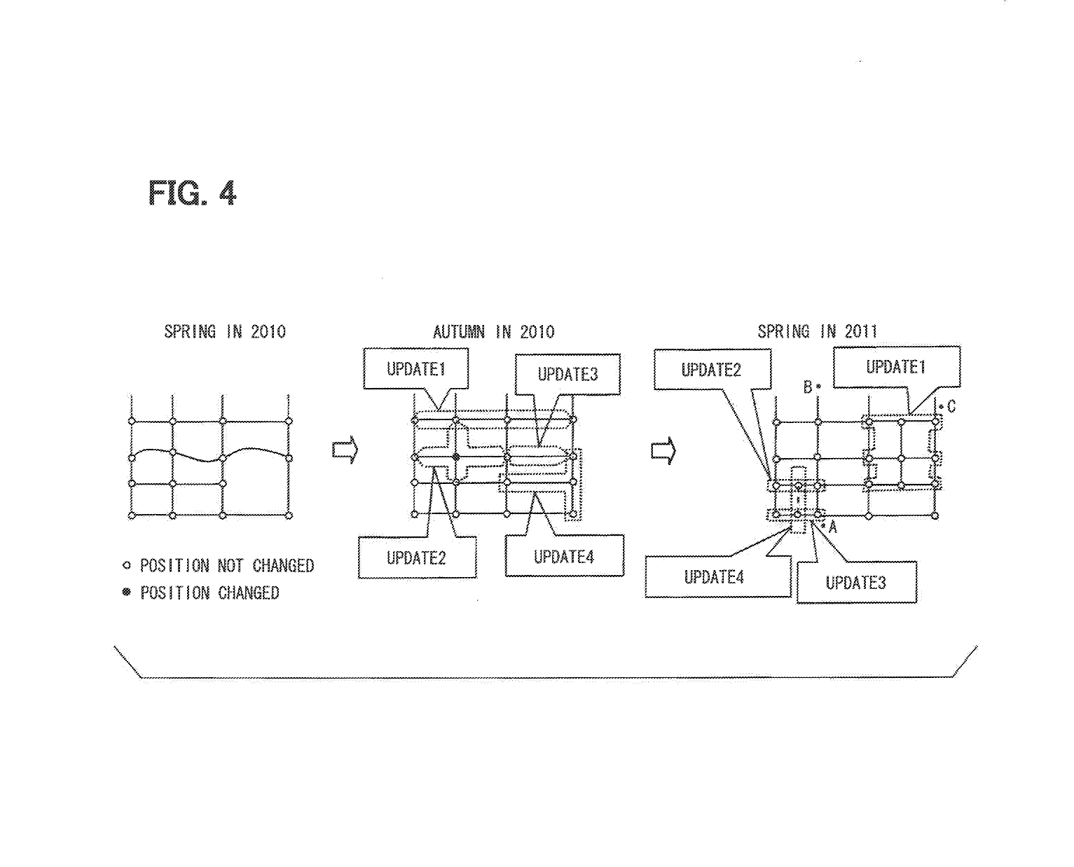

This is described below using an example. FIG. 4 shows an example of updating a road network represented by links and nodes. With reference to the spring of 2010, four locations (updates 1 through 4) are updated in the autumn of 2010. After that, four locations (updates 1 through 4) are updated in the spring of 2011.

In the autumn of 2010, update 1 provides information about a group including three serially connected links. Update 1 shows the attribute change in the links. Update 2 provides information about a group including four links connected to one node. Update 2 shows the node position change and the resulting shape change in the links. Update 3 provides information about one link. Update 3 shows the link shape change. Update 4 provides information about a group that includes three links connected in a T shape and four nodes as end points of the links. Update 4 shows the change of four links and four nodes due to opening of the road. The change of four links signifies that one existing link is deleted and three new links are added. The change of four nodes signifies that one new node is added and the information about three existing nodes is updated.

In the spring of 2011, update 1 provides information about a group that includes eight links connected vertically and horizontally and nine nodes as end points of the links. Update 1 shows the change of 11 links and nine nodes due to opening of the road. The change of 11 links signifies that three existing links are deleted and eight new links are added. The change of nine nodes signifies that three new nodes are added and the information about six existing nodes is updated. Updates 2 and 3 provide information about a group that includes two serially connected links and three nodes as end points of the links. Updates 2 and 3 show the change of three links and three nodes due to opening of the sidewalk. The change of three links signifies that one existing link is deleted and two new links are added. The change of three nodes signifies that one new node is added and the information about two existing nodes is updated. Update 4 provides information about a group that includes one link and two nodes as end points of the link. Update 4 shows addition of one sidewalk link and addition of two new nodes due to opening of the sidewalk.

According to the example in FIG. 4, updates 2 and 3 in the autumn of 2010 show the change of the link shape itself. The updates are not distributed independently because the navigation apparatus 2 based on the normal accuracy does not need the updates. However, the link for the update 3 in the autumn of 2010 is subject to the NW change due to update 1 in the spring of 2011. The link shape needs to be changed in order to keep the map data consistent if the map data reflects update 1 in the spring of 2011. The difference data item representing update 1 in the spring of 2011 needs to be distributed as well as the difference data item representing update 3 in the spring of 2010.

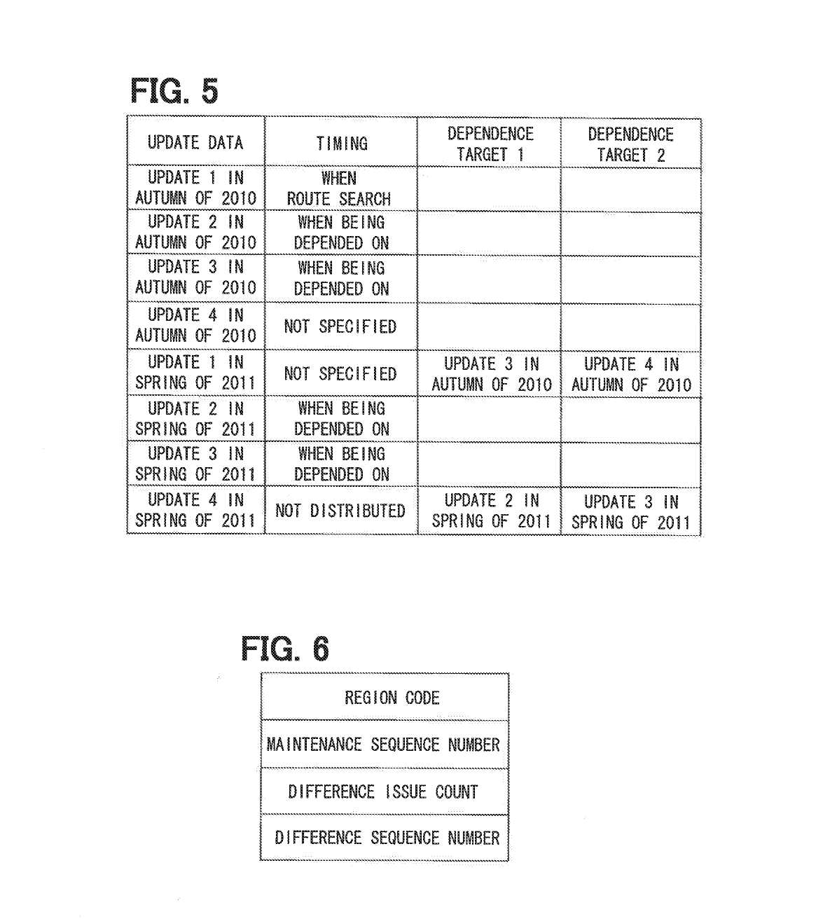

There is dependence relationship between update 1 in the spring of 2011 and update 3 in the autumn of 2010 while the latter is assumed to be a dependence target. FIG. 5 shows dependence targets for the updates in the example of FIG. 4. This information is stored in the difference information DB 12. Update 1 in the spring of 2011 has the dependence relationship with updates 3 and 4 in the autumn of 2010 while these updates are assumed to be dependence targets. That is, the difference data item representing update 1 in the spring of 2011 is distributed as well as updates 3 and 4 in the autumn of 2010. Update 4 in the spring of 2011 has the dependence relationship with updates 2 and 3 in the spring of 2011 while these updates are assumed to be dependence targets. That is, the difference data item representing update 4 in the spring of 2011 is distributed as well as updates 2 and 3 in the spring of 2011.

For example, suppose that the navigation apparatus 2 stores the map data in the spring of 2010 and that point A is assumed to be a start point and point B is assumed to be a destination. Then, the navigation apparatus 2 travels the link whose shape is changed due to update 2 in the autumn of 2010. However, the navigation apparatus 2 does not require the difference data item representing update 2. Therefore, this difference data item is not distributed. On the other hand, suppose that point A is assumed to be a start point and point C is assumed to be a destination. Then, the navigation apparatus 2 requires the difference data item representing update 1 in the autumn of 2010 and the difference data item representing update 1 in the spring of 2011. In addition, the navigation apparatus 2 requires the difference data items representing updates 3 and 4 in the autumn of 2011 as dependence targets for update 1 in the spring of 2011. Therefore, the difference map distribution server 1 distributes these difference data items at a one time to the navigation apparatus 2.

If a difference data item is categorized into the shape change, the navigation apparatus 2 based on the high accuracy may use that difference data item for a vehicle control process that uses the map data. In consideration of this, the user distribution history DB 13 stores (navigation apparatus-specific) information about the usage of a difference data item categorized into the shape change corresponding to each of the navigation apparatuses 2 to which the difference data item is to be distributed. Even a difference data item categorized into the shape change is independently distributed to the navigation apparatus 2 that uses the difference data item categorized into the shape change.

Another example is a difference data item that represents a sidewalk. The navigation apparatus 2 fixedly mounted on a vehicle is not used for sidewalks. In such a case, the difference data item representing sidewalks is assumed to be irrelevant contents. The examples are updates 2 through 4 in the spring of 2011 as shown in FIG. 4. The difference data item representing sidewalks are excluded from extraction candidates and are not independently distributed to this type of navigation apparatus 2. On the other hand, there may be portable navigation apparatus 2 that can be carried out of the vehicle and can be used for sidewalks. In consideration of this, the user distribution history DB 13 stores information about the usage of a difference data item representing the sidewalk corresponding to each of the navigation apparatuses 2 to which the difference data item is to be distributed. Even a difference data item representing the sidewalk is independently distributed to the navigation apparatus 2 that uses the difference data item representing the sidewalk. There may be a difference data item that is not required at all for the navigation apparatus 2 as a distribution target. Such a difference data item represents irrelevant contents and has no dependence relationship with a difference data item to be distributed. The irrelevant difference data item is excluded from extraction candidates and is not distributed.

The difference map distribution server 1 prevents the same difference data item from being redundantly distributed to the same navigation apparatus 2. For this purpose, the difference map distribution server 1 excludes the difference data item already distributed to the targeted navigation apparatus 2 from extraction candidates based on the distribution history of difference data stored in the user distribution history DB 13. Specifically, the distributed difference data item is provided with identification information (difference data ID) corresponding to each navigation apparatus 2. The difference data ID is associated with maintenance map data (e.g., national or regional edition) distributed to users in the form of DVDs and SD cards.

As shown in FIG. 6, for example, the difference data ID includes a region code, a maintenance sequence number, a difference issuance count, and a difference sequence number. The region code represents prefectural and city governments to which a difference data item belongs. The maintenance sequence number represents the corresponding maintenance map data. The difference issuance count represents the number of releases after the maintenance map data. The difference sequence number represents a sequence number given to the difference data item within one difference release.

The difference map distribution server 1 stores a (navigation apparatus-specific) distribution history of difference data items based on the difference data ID in the user distribution history DB 13 corresponding to each navigation apparatus 2. The difference map distribution server 1 compares the difference data ID of a difference data item to be distributed with the difference data ID stored in the user distribution history DB 13 to determine whether the difference data item is already distributed. The difference map distribution server 1 then distributes the undistributed difference data item.

### 5. Distributing Difference Data Used for the Map Display Process

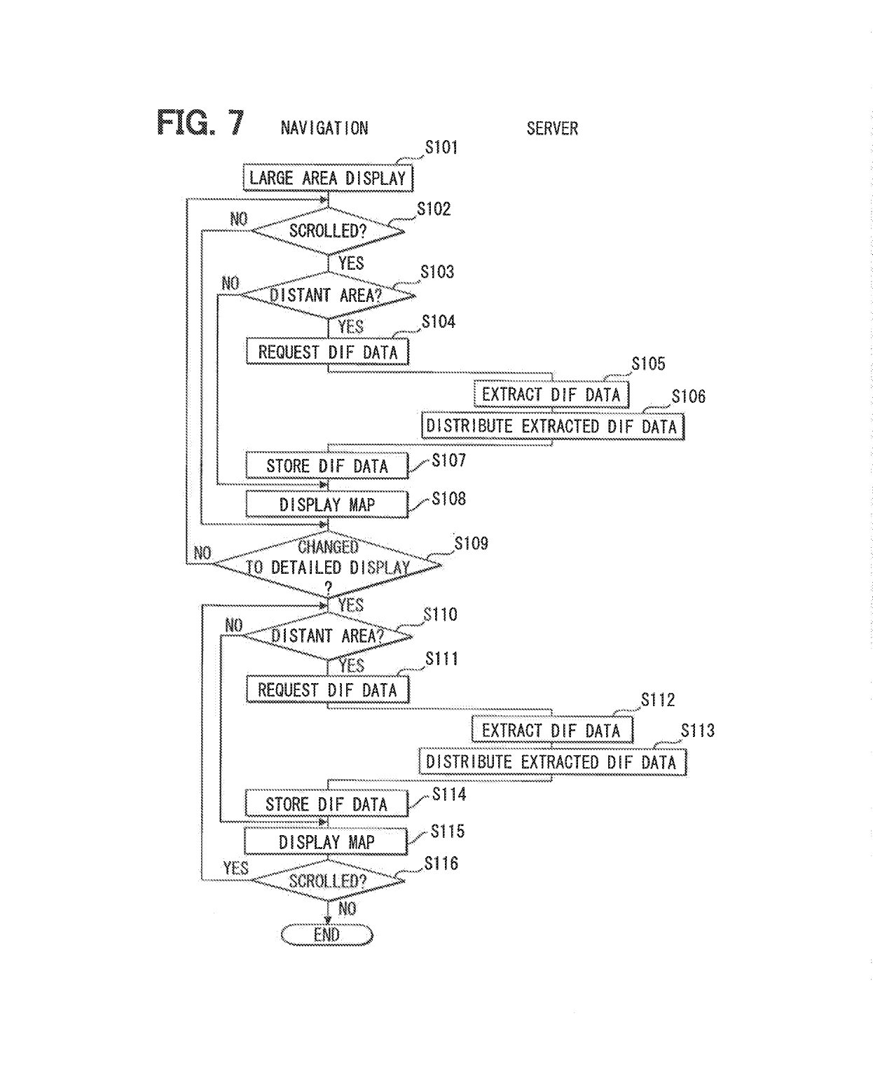

A flowchart in FIG. 7 exemplifies processes performed on the difference map distribution server 1 and the navigation apparatus 2 while the navigation apparatus 2 performs the map display process. The following description assumes that a user searches the displayed map image for an intended place such as a destination of the route search. For this purpose, the user first scrolls the map image in large area display to find an approximate location. The user then enlarges the map image and specifies the accurate place on the map image in detailed display.

It is noted that a flowchart or the processing of the flowchart in the present application includes sections (also referred to as steps), each of which is represented, for instance, as S101. Further, each section can be divided into several sub-sections while several sections can be combined into a single section. Furthermore, each of thus configured sections can be also referred to as a device, means, or module.

Each or any combination of sections explained in the above can be achieved as (i) a software section in combination with a hardware unit (e.g., computer) or (ii) a hardware section, including or not including a function of a related apparatus; furthermore, the hardware section may be constructed inside of a microcomputer.

Furthermore, the software section may be included in a software program, which may be contained in a non-transitory computer-readable storage media as a program product.

The navigation processor 26 of the navigation apparatus 2 displays the map image in a large area on a display portion of the HMI portion 27 (S101). In this state, the navigation processor 26 determines whether an input portion of the HMI portion 27 is used to scroll the map image in order to find an approximate location (S102).

The navigation processor 26 may determine that the scroll is performed (YES at S102). In this case, the navigation processor 26 determines whether the center of the scrolled map image is positioned within a distant area (e.g., outside the prefectural or city government for the user's home) (S103). The navigation processor 26 may determine that the center of the scrolled map image is positioned within the distant area (YES at S103). In this case, the navigation processor 26 requests difference data from the difference map distribution server 1 (S104). Specifically, the navigation processor 26 transmits request information to the difference map distribution server 1 via the distribution request portion 28 and the network I/F 21. The request information indicates a request for difference data used for the map display process and contains information about the center coordinates of the scrolled map image and its scale.

The difference data extraction portion 16 of the difference map distribution server 1 receives the request information from the navigation apparatus 2 via the network I/F 11 and the distribution controller 17. The difference data extraction portion 16 extracts a difference data item needed for the map display process from types of update information stored in the difference information DB 12 based on the information about the center coordinates of the map image and its scale contained in the request information (S105). The difference data extraction method is described above in detail. The difference data extraction portion 16 extracts an undistributed difference data item that belongs to the area of the displayed map image and is categorized into the NW change.

The difference data extraction portion 16 distributes the extracted difference data item to the requesting navigation apparatus 2 via the distribution controller 17 and the network I/F 11 (S106). If there is no difference data item to be distributed, the difference data extraction portion 16 notifies this to the navigation apparatus 2.

The distribution request portion 28 of the navigation apparatus 2 receives the difference data item from the difference map distribution server 1 as a response to the request information via the network I/F 21. The distribution request portion 28 then allows the difference data storage portion 23 to store the received difference data item (S107). The navigation processor 26 displays the scrolled map image on the display portion of the HMI portion 27 using the map data generated from the difference merge portion 24 (S108). This map data results from merging a difference data item stored in the difference data storage portion 23 with the map data stored in the base map storage portion 22.

The displayed map image reflects the difference data item that is received from the difference map distribution server 1. There may be a case where, the difference map distribution server 1 notifies the absence of a difference data item to be distributed. There may be another case where the determination process concludes that the center of the scrolled map image is not positioned within the distant area and is positioned within the neighboring area (NO at S103). In such cases, the displayed map image reflects the difference data item already stored in the difference data storage portion 23.

No scroll may be determined to be performed after the map image is displayed or the determination process is performed (NO at S102). In this case, the navigation processor 26 determines whether the input portion of the HMI portion 27 is used for the enlargement in order to change the map image scale to the detailed display (S109). If no enlargement is determined to be performed (NO at S109), the above-mentioned process (S102 through S108) is repeated.

If the enlargement is determined to be performed (YES at S109), the navigation processor 26 determines whether the center of the map image changed to the detailed display is positioned within the distant area (S110). If the determination is affirmative (YES at S110), the navigation processor 26 requests difference data from the difference map distribution server 1 (S111). Specifically, the navigation processor 26 transmits request information to the difference map distribution server 1 via the distribution request portion 28 and the network I/F 21. The request information indicates a request for difference data used for the map display process and contains information about the center coordinates of the map image changed to the detailed display and the scale thereof.

The difference data extraction portion 16 of the difference map distribution server 1 receives the request information from the navigation apparatus 2 via the network I/F 11 and the distribution controller 17. The difference data extraction portion 16 extracts a difference data item needed for the map display process from types of update information stored in the difference information DB 12 based on the information about the center coordinates of the map image and its scale contained in the request information (S112). The difference data extraction portion 16 distributes the extracted difference data item to the requesting navigation apparatus 2 via the distribution controller 17 and the network I/F 11 (S113).

The distribution request portion 28 of the navigation apparatus 2 receives the difference data item from the difference map distribution server 1 as a response to the request information via the network I/F 21. The distribution request portion 28 allows the difference data storage portion 23 to store the received difference data item (S114). The navigation processor 26 uses the map data generated from the difference merge portion 24 to display the map image changed to the detailed display on the display portion of the HMI portion 27 (S115).

The navigation processor 26 determines whether the input portion of the HMI portion 27 is used to scroll the map image in order to specify the accurate location (S116).

If the scroll is determined to be performed (YES at S116), the navigation processor 26 determines whether the center of the scrolled map image is positioned within the distant area (S110). If the determination is affirmative (YES at S110), the navigation processor 26 requests difference data from the difference map distribution server 1 similarly to the large area display (S111).

The difference data extraction portion 16 of the difference map distribution server 1 receives the request information from the navigation apparatus 2 via the network I/F 11 and the distribution controller 17. The difference data extraction portion 16 extracts a difference data item needed for the map display process from types of update information stored in the difference information DB 12 based on the information about the center coordinates of the map image and its scale contained in the request information (S112). The difference data extraction portion 16 distributes the extracted difference data item to the requesting navigation apparatus 2 via the distribution controller 17 and the network I/F 11 (S113).

The distribution request portion 28 of the navigation apparatus 2 receives the difference data item from the difference map distribution server 1 as a response to the request information via the network I/F 21. The distribution request portion 28 allows the difference data storage portion 23 to store the received difference data item (S114). The navigation processor 26 uses the map data generated from the difference merge portion 24 to display the scrolled map image on the display portion of the HMI portion 27 (S115). The scroll terminates when the user finds the intended location (NO at S116).

As described above, the difference map distribution server 1 distributes a difference data item to the navigation apparatus 2 if the navigation apparatus 2 requires that difference data item for the map display process. However, there may be a difference data item not used for the map image depending on scales even though the difference data item, undistributed, belongs to the area of the displayed map image and is categorized into the NW change. Such a difference data item may not be extracted. For example, the difference data item for update 5 in FIG. 2 shows that C-IC is opened. This difference data item is too small to be displayed on the map image in the large area display. The difference data item can be prevented from being distributed depending on scales.

### 6. Distributing Difference Data Used for the Route Search Process

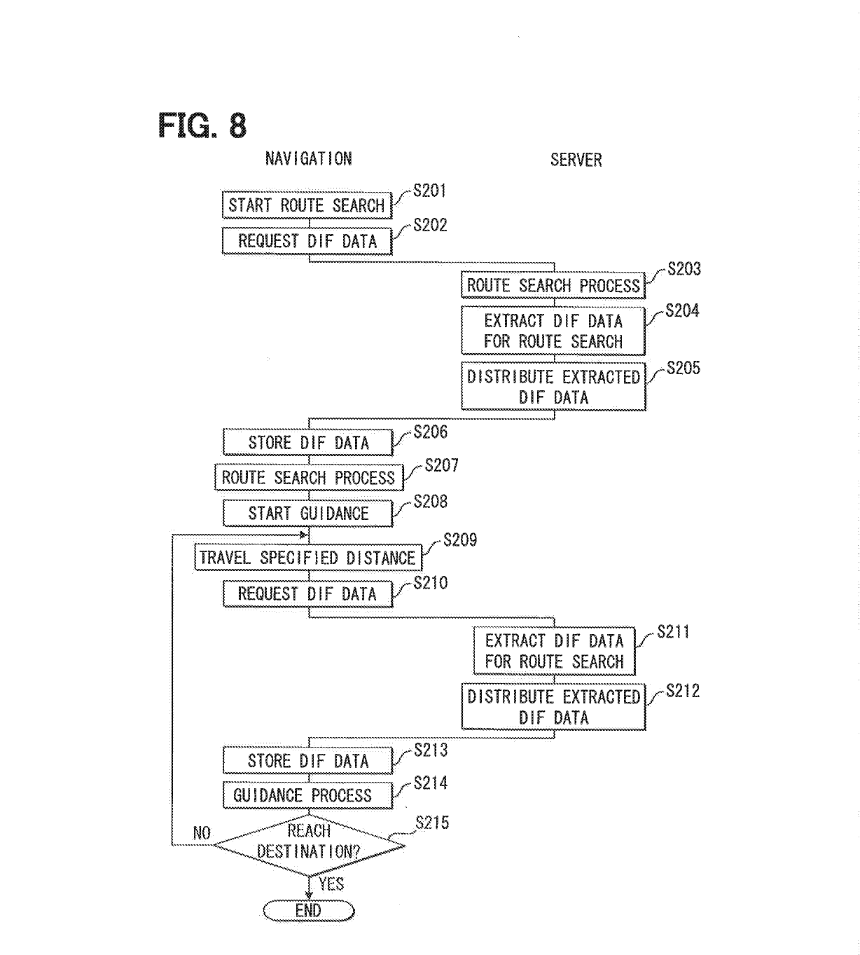

A flowchart in FIG. 8 exemplifies processes performed on the difference map distribution server 1 and the navigation apparatus 2 when the user manipulates the navigation apparatus 2 to start the route search process. The route search process is provided with a destination as a search condition. The map display process may specify the destination on the map image as shown in FIG. 7. The destination may be searched for based on POI (Point of Interest) information or facility information.

The navigation processor 26 of the navigation apparatus 2 detects that the input portion of the HMI portion 27 is used to start the route search process (S201). The navigation processor 26 then requests difference data from the difference map distribution server 1 (S202). Specifically, the navigation processor 26 transmits request information to the difference map distribution server 1 via the distribution request portion 28 and the network I/F 21. The request information indicates a request for difference data used for the route search process and contains information that is needed for the route search process and provides a search condition including the present location and the destination. The present location and the destination are provided as coordinates (position information) representing the latitude and the longitude, for example. The search condition includes route information and the priority given to an ordinary road, a highway, or a distance as well as the present location and the destination, for example.

The route search portion 15 of the difference map distribution server 1 receives the request information about the difference data from the navigation apparatus 2 via the network I/F 11 and the distribution controller 17. The route search portion 15 performs the route search process (S203) based on the search condition contained in the request information using the most recent map data that reflects all the difference data items stored in the difference information DB 12. The difference data extraction portion 16 of the difference map distribution server 1 extracts an undistributed difference data item from types of update information stored in the difference information DB 12 (S204). The difference data item to be extracted belongs to the searched route and is categorized into the NW change or the attribute change. The difference data extraction portion 16 distributes the extracted difference data item to the requesting navigation apparatus 2 via the distribution controller 17 and the network I/F 11 (S205). In the example of FIG. 2, suppose that the route is searched for from the present location to the destination using the highway from B-IC to C-IC. In this case, the difference data extraction portion 16 distributes difference data items for updates 1, 4, and 5.

The distribution request portion 28 of the navigation apparatus 2 receives the difference data items from the difference map distribution server 1 as a response to the request information via the network I/F 21. The distribution request portion 28 allows the difference data storage portion 23 to store the received difference data items (S206). The navigation processor 26 uses the map data generated from the difference merge portion 24 to perform the route search process based on the search condition (S207). The navigation processor 26 may use the route information that is received from and is searched by the difference map distribution server 1.

The navigation processor 26 detects that the input portion of the HMI portion 27 is used to start the guidance process along the searched route (S208). The navigation processor 26 then determines whether a vehicle mounted with the navigation apparatus 2 travels a specified distance (S209). When the vehicle is determined to travel a specified distance, the navigation processor 26 requests difference data from the difference map distribution server 1 (S210). Specifically, the navigation processor 26 transmits request information to the difference map distribution server 1 via the distribution request portion 28 and the network I/F 21. The request information indicates a request for difference data used for the guidance process and contains information about coordinates of the present location and the scale of the displayed map image.

The difference data extraction portion 16 of the difference map distribution server 1 receives the request information from the navigation apparatus 2 via the network I/F 11 and the distribution controller 17. The difference data extraction portion 16 extracts an undistributed difference data item from types of update information stored in the difference information DB 12 (S211) based on the information about coordinates of the present location and the scale of the displayed map image contained in the request information. The difference data item to be extracted belongs to the guidance route from the present location to the specified distance destination and is categorized into the NW change or the guidance information change. The above-mentioned route search process (S203) specifies the guidance route. The guidance route to the specified distance destination may belong to an area in the map image displayed on the received scale, for example.

The difference data extraction portion 16 distributes the extracted difference data item to the requesting navigation apparatus 2 via the distribution controller 17 and the network I/F 11 (S212). In the example of FIG. 2, suppose that the guidance process is performed along the route from the present location to the destination using the highway from B-IC to C-IC. In this case, the difference data extraction portion 16 distributes the difference data item for update 6 in accordance with the present location.

The distribution request portion 28 of the navigation apparatus 2 receives the difference data item from the difference map distribution server 1 as a response to the request information via the network I/F 21. The distribution request portion 28 then allows the difference data storage portion 23 to store the received difference data item (S213). The navigation processor 26 performs the guidance process (S214) using the map data generated from the difference merge portion 24.

The process (S209 through S214) is repeated until the destination is reached (NO at S215). The guidance process terminates if the destination is reached (YES at S215).

The navigation processor 26 periodically requests difference data while performing the guidance process. The timing to request the difference data is not limited to the specified distance traveled. For example, the navigation processor 26 may request the difference data each time a specified time period elapses.

### 7. Effects

As described above, the map update system according to the embodiment can wirelessly transmit the update information occurred at the same link or node during the same period using different types of update information. The difference data items are categorized into the NW change, the shape change, the attribute change, and the guidance information change according to uses of the map data, that is, the update information types. The map update system can suppress the communication traffic to wirelessly distribute difference data in comparison with a conventional configuration that wirelessly distributes all the information update occurred at the same link or node during the same period.

Particularly, the map update system according to the embodiment can wirelessly distribute only a difference data item needed for a scene at which the user of the navigation apparatus 2 uses the map data. For example, the navigation apparatus 2 does not use a difference data item categorized into the shape change or the guidance information if the navigation apparatus 2 performs the route search process. Distributing such a difference data item unnecessarily increases the communications traffic. The map update system according to the embodiment allows the navigation apparatus 2 to perform a process using the map data. To do this, the navigation apparatus 2 transmits the request information indicating the process to be performed to the difference map distribution server 1. The difference map distribution server 1 receives the request information from the navigation apparatus 2, extracts a difference data item categorized into the type of update information used for a process indicated in the request information, and distributes that difference data item. The navigation apparatus 2 performs the process using the map data reflecting the received difference data item. Based on this scheme, the difference map distribution server 1 can distribute in real-time difference data items categorized into the type of update information used for the process the navigation apparatus 2 is going to perform. For example, the difference map distribution server 1 can distribute a difference data item categorized into the type of update information used for the route search process at the timing the navigation apparatus 2 is going to perform the route search process. The difference map distribution server 1 can distribute a difference data item categorized into the type of update information used for the guidance process at the timing the navigation apparatus 2 is going to perform the guidance process. The map update system can effectively suppress distribution of extra difference data items the navigation apparatus 2 does not use at present. As a result, the map update system can shorten the map update time and update the map in real time.

In the map update system according to the embodiment, the difference map distribution server 1 receives request information indicating the route search process. The difference map distribution server 1 searches for a route corresponding to the search condition contained in the request information and identifies a difference data item associated with the searched route as an extraction candidate. The difference map distribution server 1 can distribute the difference data item associated with the route for which the navigation apparatus 2 searches using the route search process.

In the map update system according to the embodiment, the difference map distribution server 1 receives request information indicating the guidance process. The difference map distribution server 1 identifies a difference data item as an extraction candidate if the difference data item belongs to an area with reference to the present location based on coordinates of the present location and the map image scale contained in the request information. According to the above-mentioned example, the area corresponds to the guidance route from the present location to the specified distance destination. The difference map distribution server 1 can distribute the difference data item used for the guidance process in the navigation apparatus 2. Moreover, the difference map distribution server 1 distributes a difference data item needed for the guidance process more than once until a vehicle reaches the destination. The map update system can suppress distribution of an unnecessary difference data item even if the vehicle deviates from the guidance route before it reaches the destination.

In the map update system according to the embodiment, the difference map distribution server 1 receives request information indicating the map display process. The difference map distribution server 1 then specifies an area in the map image displayed based on display mode information that is contained in the request information and indicates the center coordinates and the scale of the map image according to the above-mentioned example. The difference map distribution server 1 identifies a difference data item as an extraction candidate if the difference data item exists in the specified area. The difference map distribution server 1 can distribute the difference data item used for the map display process in the navigation apparatus 2.

In the map update system according to the embodiment, the difference map distribution server 1 stores the distribution history of difference data items associated with each navigation apparatus 2. The difference map distribution server 1 excludes a difference data item already distributed to the navigation apparatus 2 from extraction candidates based on the distribution history. The map update system can decrease the possibility of redundantly distributing a difference data item already distributed to the navigation apparatus 2.

In the map update system according to the embodiment, the difference map distribution server 1 stores the dependence relationship between each difference data item with another difference data item needed to reflect that difference data item on the map data. The difference map distribution server 1 extracts a difference data item in addition to the other difference data item as the dependence target. There may be a difference data item that need not be distributed independently. If such a difference data item is not distributed, the map data reflects the other difference data item and comes to be inconsistent. The map update system can decrease such a possibility.

In the map update system according to the embodiment, the difference map distribution server 1 stores types of unused information contained in the map data corresponding to each navigation apparatus 2. The difference map distribution server 1 does not independently distribute a difference data item that is not used for the navigation apparatus 2 as the distribution target. The difference data item is excluded from extraction candidates. The map update system can decrease the amount of difference data to be distributed as well as the communications traffic.

### 8. References

According to the embodiment, the difference map distribution server 1 may be referred to as a map data distribution apparatus. The navigation apparatus 2 may be referred to as an electronic apparatus. The network I/F 11 and the distribution controller 17 may be referred to as a distribution device or means and a process information reception device or means. The difference information DB 12 may be referred to as a difference storage device or means. The user distribution history DB 13 may be referred to as a history storage device or means and an apparatus information storage device or means. The difference data extraction portion 16 may be referred to as an extraction device or means. The network I/F 21 and the distribution request portion 28 may be referred to as a process information transmission device or means and a difference data reception device or means. The navigation processor 26 may be referred to as a process device or means. The link and the node may be referred to as a road element. The map display process, the route search process, and the guidance process may be referred to as a map utilization process. The request information may be referred to as process execution information. Second difference data on which first difference data depends may be referred to as associated difference data for the first difference data. Herein, the second difference data may be also referred to as a dependence target for the first difference data.

### 9. Other Embodiments

While there have been described specific embodiments of the present disclosure, it is to be distinctly understood that the present disclosure is not limited thereto but may be otherwise variously embodied within the spirit and scope of the present disclosure.

(1) The embodiment does not independently distribute a difference data item not used for the navigation apparatus 2 as a distribution destination. Such a difference data item is excluded from extraction candidates and is distributed when the other difference data item having the dependence relationship is distributed. Instead, that difference data item may be distributed later. That is, a difference data item indicating the type of information not used for the navigation apparatus 2 is distributed to this navigation apparatus later than a difference data item indicating the type of information used for the same. For example, a difference data item indicating the type of information not used for the navigation apparatus 2 may be automatically updated at night. This can suppress communications traffic in the daytime.

(2) According to the embodiment, the difference map distribution server 1 manages the distribution history of difference data items distributed to the navigation apparatus 2 corresponding to each navigation apparatus 2 (each user). The disclosure is not limited thereto. For example, the navigation apparatus 2 may manage difference data items (distribution history) already distributed to the navigation apparatus 2 and request difference data from the difference map distribution server 1. In this case, the navigation apparatus 2 may transmit information about the distribution history such as a difference data version to the difference map distribution server 1. In this manner, the difference map distribution server 1 can receive the distribution history from the navigation apparatus 2. The difference map distribution server 1 can exclude the distributed difference data items from extraction candidates based on the received distribution history. According to this configuration, the difference map distribution server 1 can re-distribute a difference data item the navigation apparatus 2 failed to acquire normally due to unsuccessful reception or merge. In this case, the network I/F 11 and the distribution controller 17 of the difference map distribution server 1 may be referred to as a history reception device or means.

(3) According to the embodiment, the difference data items are categorized into the NW change, the shape change, the attribute change, and the guidance information change. The other categories may be available. There are definitions of the traffic information distribution systems such as VICS (Vehicle Information and Communication System: registered trademark) and RDS-TMC (Radio Data System-Traffic Message Channel). The definitions provide road information associated with data provision, for example. Difference information indicating definition changes may be categorized into an infrastructure information change. Difference data items categorized into the infrastructure information change may be distributed if a vehicle is running in the corresponding area or the route search is performed, for example.

(4) The embodiment exemplifies the navigation apparatus 2 as an electronic apparatus that performs processes using the map data. The disclosure is not limited thereto. The disclosure is also applicable to electronic apparatuses other than the navigation apparatus.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A map data distribution apparatus that functions as a server, stores map data representing a road network using a plurality of road elements, and wirelessly distributes update information contained in the map data to an electronic apparatus to perform a map utilization process using the map data, the map data distribution apparatus comprising:
a difference storage device that stores difference data items as update information about a specified road element, each of the difference data items being stored to be categorized into one of a plurality of different types of update information;
an extraction device that extracts a difference data item categorized into an extracted type of update information to be distributed to the electronic apparatus, out of the difference data items categorized into the plurality of different types of update information stored in the difference storage device; and
a distribution device that wirelessly distributes as distributed difference data the difference data item categorized into the extracted type, which is extracted by the extraction device, to the electronic apparatus.

2. The map data distribution apparatus according to claim 1, further comprising:
a process information reception device that receives process execution information from the electronic apparatus, the process execution information representing a map utilization process to be performed on the electronic apparatus,
wherein, when the process information reception device receives the process execution information, the extraction device extracts a difference data item categorized into a type of update information used for a map utilization process indicated in the received process execution information out of the difference data items categorized into the plurality of different types of update information stored in the difference storage device as the difference data item categorized into the extracted type of update information to be distributed to the electronic apparatus.

3. The map data distribution apparatus according to claim 2, wherein:
the electronic apparatus performs a route search process as the map utilization process, the route search process searching roads represented in the map data for a route in accordance with a search condition;
the different types of update information contain a type of update information used for the route search process and a type of update information not used for the route search process; and
when the process information reception device receives the process execution information indicating the route search process, the extraction device extracts a difference data item categorized into the type of update information used for the route search process out of the difference data items categorized into the different types of update information stored in the difference storage device as the difference data item categorized into the extracted type of update information to be distributed to the electronic apparatus.

4. The map data distribution apparatus according to claim 3, wherein:
the process execution information indicating the route search process contains the search condition; and
when the process information reception device receives the process execution information indicating the route search process, the extraction device specifies a specified route in accordance with the search condition contained in the process execution information received by the process information reception device and identifies a difference data item associated with the specified route as an extraction candidate.

5. The map data distribution apparatus according to claim 2, wherein:
the electronic apparatus performs a guidance process as the map utilization process, the guidance process providing guidance from a present location to a destination along a road represented by the map data;
the different types of update information contain a type of update information used for the guidance process and a type of update information not used for the guidance process; and
when the process information reception device receives the process execution information indicating the guidance process, the extraction device extracts a difference data item categorized into the type of update information used for the guidance process out of the difference data items categorized into the different types of update information stored in the difference storage device as the difference data item categorized into the extracted type of update information to be distributed to the electronic apparatus.

6. The map data distribution apparatus according to claim 5, wherein:
the process execution information indicating the guidance process contains position information about the present location; and
when the process information reception device receives the process execution information indicating the guidance process, the extraction device specifies a specified area with reference to the present location based on the position information contained in the process execution information received by the process information reception device and identifies a difference data item within the specified area as an extraction candidate.

7. The map data distribution apparatus according to claim 2, wherein:
the electronic apparatus performs a map display process as the map utilization process, the map display process displaying a map image represented by map data;
the process execution information indicating the map display process contains display mode information indicating a map image display mode; and
when the process information reception device receives the process execution information indicating the map display process, the extraction device specifies a specified area of the map image displayed based on the display mode information contained in the process execution information received by the process information reception device and identifies a difference data item within the specified area of the map image as an extraction candidate.

8. The map data distribution apparatus according to claim 1, further comprising:
a history storage device that stores an electronic apparatus-specific distribution history, which indicates distributed difference data that was already distributed to a specific electronic apparatus,
wherein the extraction device excludes a difference data item already distributed to a targeted electronic apparatus from an extraction candidate based on the electronic apparatus-specific distribution history relative to the targeted electronic apparatus stored in the history storage device.

9. The map data distribution apparatus according to claim 1, further comprising:
a history reception device that receives an electronic apparatus-specific distribution history, which indicates distributed difference data, which was already distributed to a specific electronic apparatus, from the specific electronic apparatus,
wherein the extraction device excludes a difference data item already distributed to a targeted electronic apparatus from an extraction candidate based on the electronic apparatus-specific distribution history that is received from the targeted electronic apparatus by the history reception device.

10. The map data distribution apparatus according to claim 1, wherein:
the difference storage device stores a first difference data item and a second difference data item that is an associated difference data item associated with the first difference data item, the second difference data item on which the first difference data item is dependent, the second difference data item being needed to reflect the first difference data item on the map data; and
when extracting the first difference data item, the extraction device further extracts the second difference data item as the associated difference data item in addition to the first difference data item from the difference storage device.

11. The map data distribution apparatus according to claim 1, further comprising:
an apparatus information storage device that stores an electronic apparatus-specific type of unused information contained in the map data corresponding to a specific electronic apparatus,
wherein the extraction device excludes a difference data item categorized into a type of information not used for a targeted electronic apparatus from an extraction candidate with reference to the electronic apparatus-specific type of unused information relative to the targeted electronic apparatus.

12. The map data distribution apparatus according to claim 1, further comprising:
an apparatus information storage device that stores an electronic apparatus-specific type of unused information contained in the map data corresponding to a specific electronic apparatus,
wherein the extraction device distributes a difference data item categorized into a type of information not used for a targeted electronic apparatus later than a difference data item categorized into a type of information used for the targeted electronic apparatus with reference to the electronic apparatus-specific type of unused information relative to the targeted electronic apparatus.

13. An electronic apparatus that stores map data representing a road network using a plurality of road elements, the electronic apparatus performing a map utilization process using the map data, the electronic apparatus cooperating with a server that wirelessly distributes update information contained in the map data, the electronic apparatus comprising:
a process information transmission device that wirelessly transmits process execution information to the server when performing the map utilization process, the process execution information representing the map utilization process to be performed;
a difference data reception device that wirelessly receives a difference data item categorized into an extracted type of update information from the server,
the difference data item categorized into the extracted type of update information being extracted out of difference data items categorized into a plurality of different types of update information with respect to a specified road element by the server in response to the process execution information transmitted by the process information transmission device; and
a process device that performs the map utilization process using map data on which the difference data item categorized into the extracted type of update information is reflected.

14. A map update system comprising:
an electronic apparatus that stores map data representing a road network using a plurality of road elements, the electronic apparatus performing a map utilization process using the map data; and
a server that wirelessly distributes distributed difference data representing update information contained in the map data,
the electronic apparatus being further configured to include:
a process information transmission device that wirelessly transmits, when performing the map utilization process, process execution information representing the map utilization process to the server;
a difference data reception device that wirelessly receives the distributed difference data from the server as a response to the process execution information transmitted by the process information transmission device; and
a process device that performs the map utilization process using map data on which the distributed difference data received by the difference data reception device is reflected,
the server being further configured to include:
a difference storage device that stores difference data items as update information about a specified road element, each of the difference data items being stored to be categorized into one of a plurality of different types of update information;
a process information reception device that receives the process execution information from the electronic apparatus;
an extraction device that extracts, when the process information reception device receives the process execution information from the electronic apparatus, a difference data item categorized into an extracted type of update information out of the difference data items categorized into the plurality of different types of update information stored in the difference storage device, the difference data item categorized into the extracted type of update information being to be used in the map utilization process indicated by the process execution information transmitted from the electronic apparatus; and
a distribution device that wirelessly distributes as the distributed difference data the difference data item categorized into the extracted type of update information, which is extracted by the extraction device, to the electronic apparatus.
